(19) United States
(12) Patent Application Publication
(10) Pub. No.: US 2022/0202539 A1
(43) Pub. Date: Jun. 30, 2022

(54) DENTAL IMPLANT

(71) Applicant: Industrial Technology Research Institute, Hsinchu (TW)

(72) Inventors: Ming-Jun Li, Yunlin County (TW); Yu-Tsung Chiu, Taipei City (TW)

(73) Assignee: Industrial Technology Research Institute, Hsinchu (TW)

(21) Appl. No.: 17/137,355

(22) Filed: Dec. 30, 2020

(51) Int. Cl. A61C 8/00

(52) U.S. Cl. CPC A61C 8/0018; A61C 8/0016

(57) ABSTRACT

A dental implant, having a central cavity and a strength adjusting structure, is provided. A first opening of the central cavity and a second opening of the strength adjusting structure are both located on a top surface of the dental implant. The strength adjusting structure is located between the central cavity and a side surface of the dental implant. A ratio of a first depth of the strength adjusting structure in a length direction of the dental implant to a second depth of the central cavity in the length direction of the dental implant is greater than 0 and less than or equal to 0.8.

### BACKGROUND

### Technical Field

The disclosure relates to an implant, and particularly relates to a dental implant.

### Description of Related Art

Along with increase of age, especially the elderly population over 65, their teeth may gradually fall out. In addition, if oral health care is not good, serious problems such as periodontal disease and tooth decay may probably result in removal of natural teeth and dental implant surgery to provide functions of the original teeth. However, the most common problem in clinical practice is that a dental pin is damaged due to improper use after a period of time of dental implantation. Since a tooth and a corresponding nerve are extracted during the dental implantation, a patient may not feel a strength of an occluding force of the teeth. As a result, the occluding force of the patient is often too large and the dental pin will eventually be destroyed.

### SUMMARY

The disclosure provides a dental implant having a central cavity and a strength adjusting structure. A first opening of the central cavity and a second opening of the strength adjusting structure are both located on a top surface of the dental implant. The strength adjusting structure is located between the central cavity and a side surface of the dental implant. A ratio of a first depth of the strength adjusting structure in a length direction of the dental implant to a second depth of the central cavity in the length direction of the dental implant is greater than 0 and less than or equal to 0.8.

In an embodiment of the disclosure, the strength adjusting structure continuously surrounds the central cavity.

In an embodiment of the disclosure, the strength adjusting structure includes a plurality of independent grooves separated from each other, and the independent grooves are distributed around the central cavity.

In an embodiment of the disclosure, a number of the independent grooves is less than or equal to 30.

In an embodiment of the disclosure, the strength adjusting structure is filled with a polymer material.

In an embodiment of the disclosure, a Young's modulus of the polymer material in the strength adjusting structure is greater than or equal to 500 MPa and less than or equal to 4000 MPa.

In an embodiment of the disclosure, a minimum wall thickness of the dental implant between the central cavity and the strength adjusting structure is greater than or equal to 0.1 mm.

In an embodiment of the disclosure, a ratio of a first minimum wall thickness of the dental implant between the central cavity and the strength adjusting structure to a second minimum wall thickness of the dental implant between the strength adjusting structure and the side surface is greater than or equal to 0.1 and less than or equal to 5.

Several exemplary embodiments accompanied with figures are described in detail below to further describe the disclosure in details.

### BRIEF DESCRIPTION OF THE DRAWINGS

The accompanying drawings are included to provide a further understanding of the disclosure, and are incorporated in and constitute a part of this specification. The drawings illustrate embodiments of the disclosure and, together with the description, serve to explain the principles of the disclosure.

FIG. 1 is a three-dimensional view of a dental implant according to an embodiment of the disclosure.

FIG. 2 is a cross-sectional view of the dental implant of FIG. 1.

FIG. 3 is a schematic diagram of a model used for stress analysis of the dental implant of FIG. 1.

FIG. 4A and FIG. 4B are respectively stress distribution diagrams obtained through stress analysis of surrounding bones when a conventional dental implant and the dental implant of the embodiment of the disclosure are used.

FIG. 5A and FIG. 5B are respectively stress distribution diagrams obtained through stress analysis of dental implants when a conventional dental implant and the dental implant of the embodiment of the disclosure are used.

FIG. 6A and FIG. 6B are respectively diagrams showing a relationship between a maximum stress on a built-in screw and a depth of a strength adjusting structure when a vertical force and an oblique force are applied to the dental implant of the embodiment of the disclosure.

FIG. 7A and FIG. 7B are respectively diagrams showing a relationship between a maximum stress on a dental implant and a depth of a strength adjusting structure when a vertical force and an oblique force are applied to the dental implant of the embodiment of the disclosure.

FIG. 8A and FIG. 8B are respectively diagrams showing a relationship between a maximum stress on a surrounding bone and a depth of a strength adjusting structure when a vertical force and an oblique force are applied to the dental implant of the embodiment of the disclosure.

FIG. 9A and FIG. 9B are respectively diagrams showing a relationship between a maximum deformation amount of a surrounding bone and a depth of a strength adjusting structure when a vertical force and an oblique force are applied to the dental implant of the embodiment of the disclosure.

FIG. 10A and FIG. 10B are respectively diagrams showing a relationship between a maximum stress on a built-in screw and a ratio of a first minimum wall thickness to a second minimum wall thickness when a vertical force and an oblique force are applied to the dental implant of the embodiment of the disclosure.

FIG. 11A and FIG. 11B are respectively diagrams showing a relationship between a maximum stress on the dental implant and a ratio of a first minimum wall thickness to a second minimum wall thickness when a vertical force and an oblique force are applied to the dental implant of the embodiment of the disclosure.

FIG. 12A and FIG. 12B are respectively diagrams showing a relationship between a maximum stress on a surrounding bone and a ratio of a first minimum wall thickness to a second minimum wall thickness when a vertical force and an oblique force are applied to the dental implant of the embodiment of the disclosure.

FIG. 13A and FIG. 13B are respectively diagrams showing a relationship between a maximum deformation amount of a surrounding bone and a ratio of a first minimum wall thickness to a second minimum wall thickness when a vertical force and an oblique force are applied to the dental implant of the embodiment of the disclosure.

FIG. 14 is a schematic cross-sectional view of a dental implant according to another embodiment of the disclosure.

FIG. 15A and FIG. 15B are respectively diagrams showing a relationship between a maximum stress on a built-in screw and the number of independent grooves of a strength adjusting structure when a vertical force and an oblique force are applied to the dental implant of the embodiment of the disclosure.

FIG. 16A and FIG. 16B are respectively diagrams showing a relationship between a maximum stress on the dental implant and the number of independent grooves of a strength adjusting structure when a vertical force and an oblique force are applied to the dental implant of the embodiment of the disclosure.

FIG. 17A and FIG. 17B are respectively diagrams showing a relationship between a maximum stress on a surrounding bone and the number of independent grooves of a strength adjusting structure when a vertical force and an oblique force are applied to the dental implant of the embodiment of the disclosure.

FIG. 18A and FIG. 18B are respectively diagrams showing a relationship between a maximum deformation amount of a surrounding bone and the number of independent grooves of a strength adjusting structure when a vertical force and an oblique force are applied to the dental implant of the embodiment of the disclosure.

FIG. 19 is a schematic cross-sectional view of a dental implant according to still another embodiment of the disclosure.

FIG. 20A and FIG. 20B are respectively diagrams showing a relationship between a maximum stress on a built-in screw and Young's modulus of a polymer material when a vertical force and an oblique force are applied to the dental implant of the embodiment of the disclosure.

FIG. 21A and FIG. 21B are respectively diagrams showing a relationship between a maximum stress on the dental implant and Young's modulus of a polymer material when a vertical force and an oblique force are applied to the dental implant of the embodiment of the disclosure.

FIG. 22A and FIG. 22B are respectively diagrams showing a relationship between a maximum stress on a surrounding bone and Young's modulus of a polymer material when a vertical force and an oblique force are applied to the dental implant of the embodiment of the disclosure.

FIG. 23A and FIG. 23B are respectively diagrams showing a relationship between a maximum deformation amount of a surrounding bone and Young's modulus of a polymer material when a vertical force and an oblique force are applied to the dental implant of the embodiment of the disclosure.

### DETAILED DESCRIPTION OF DISCLOSED EMBODIMENTS

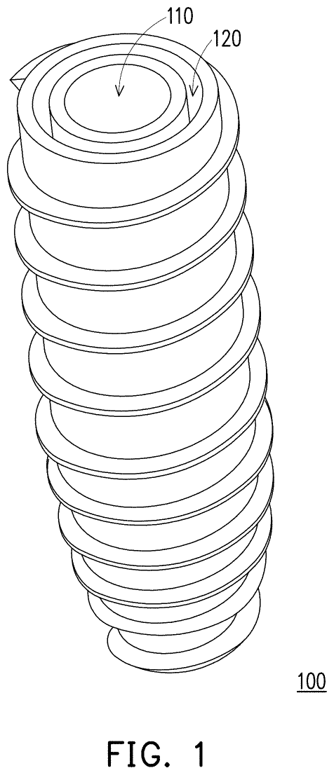

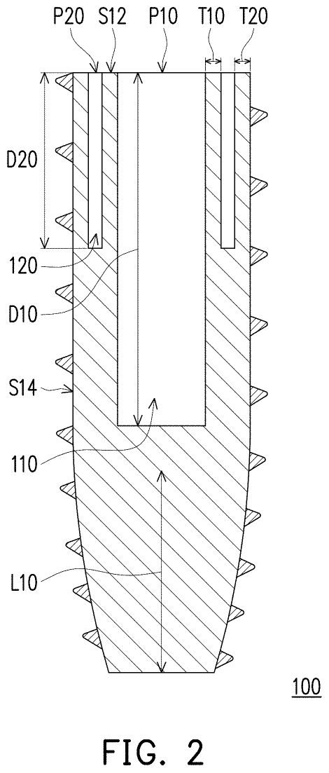

FIG. 1 is a three-dimensional view of a dental implant according to an embodiment of the disclosure. FIG. 2 is a cross-sectional view of the dental implant of FIG. 1. Referring to FIG. 1 and FIG. 2, a dental implant 100 of the embodiment has a central cavity 110 and a strength adjusting structure 120. A first opening P10 of the central cavity 110 and a second opening P20 of the strength adjusting structure 120 are both located on a top surface S12 of the dental implant 100. In other words, both of the central cavity 110 and the strength adjusting structure 120 are spaces extending downward from the top surface S12 of the dental implant 100, rather than pores or other forms of spaces buried in the dental implant 100. The strength adjusting structure 120 is located between the central cavity 110 and a side surface S14 of the dental implant 100. A ratio of a first depth D20 of the strength adjusting structure 120 in a length direction L10 of the dental implant 100 to a second depth D10 of the central cavity 110 in the length direction L10 of the dental implant 100 is greater than 0 and less than or equal to 0.8.

The dental implant 100 is an implant that is fixed on a jawbone of a patient, i.e., an implant that is directly contacted with and fixed on the jawbone of the patient. The central cavity 110 of the dental implant 100 is used to accommodate a built-in fixture (not shown), and then an artificial dental crown (not shown) customized according to the needs of the patient is installed on the top of the built-in fixture.

In the dental implant 100 of the embodiment, by configuring the strength adjusting structure 120, a structural strength of a sidewall of the dental implant 100 may be appropriately weakened. In this way, a toughness of the dental implant 100 may be improved. In addition, during an occluding process of the patient using the dental implant 100, an external force received by the dental implant 100 may be dispersedly transmitted, which reduces a stress on the dental implant 100 and the surrounding jawbone, thereby avoiding damaging the dental implant 100 or even the jawbone due to an excessive occluding force. Therefore, the dental implant 100 of the embodiment has a longer service life.

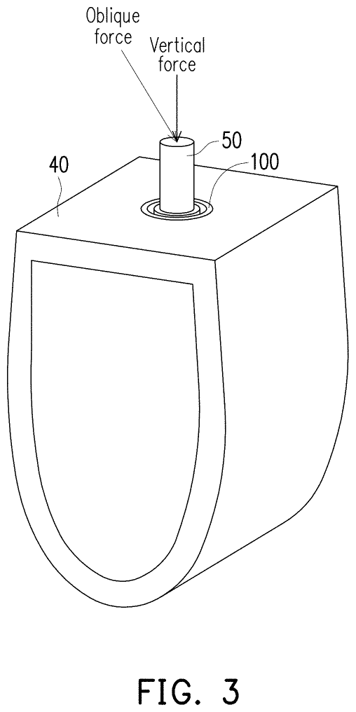

FIG. 3 is a schematic diagram of a model used for stress analysis of the dental implant of FIG. 1. In order to learn stress distributions of a conventional dental implant and the dental implant 100 in actual applications, a model shown in FIG. 3 is established. In addition, in FIG. 3, the dental implant 100 of the embodiment of the disclosure is, for example, placed, but it may also be replaced with the conventional dental implant without a strength adjusting structure to implement stress analysis of a comparative example. A bone 40 in the model of FIG. 3 is divided into two layers, which are respectively a compact bone of an outer ring and a cancellous bone in an inner ring. The central cavity 110 of the dental implant 100 accommodates a built-in fixture, such as a built-in screw 50. The bone in the model is set to be fully restrained without any displacement. When the built-in fixture is the built-in screw 50, a cavity wall of the central cavity 110 of the dental implant 100 may be provided with corresponding threads, but the threads are not illustrated in FIG. 1 and FIG. 2.

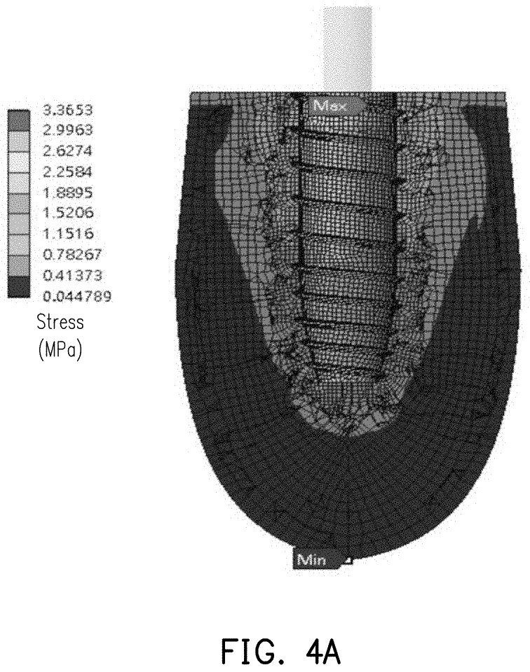

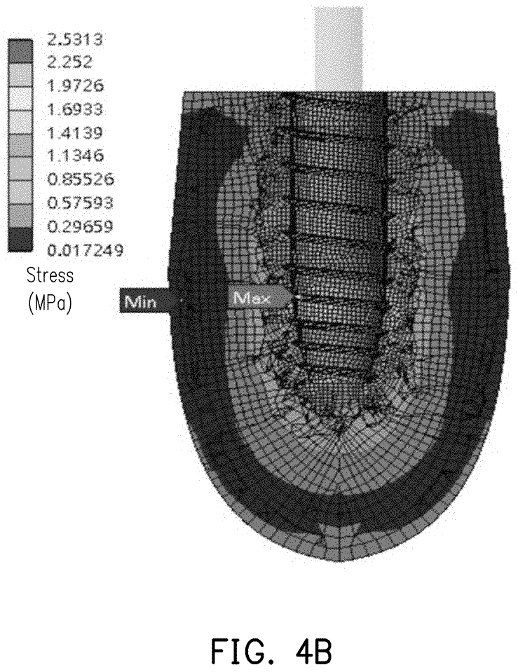

FIG. 4A and FIG. 4B are respectively stress distribution diagrams obtained through stress analysis of surrounding bones when a conventional dental implant and the dental implant of the embodiment of the disclosure are used. In FIG. 4A and FIG. 4B, the stress analysis is performed based on the model of FIG. 3, and a vertical force is applied from the top of the built-in screw. According to FIG. 4A, it is known that when a conventional dental implant is used and a vertical force is applied from the top of the built-in screw, a position where the surrounding bone receives the maximum stress (Max) is approximately a position where the surrounding bone is in contact with the top of the dental implant, and a position of the minimum stress (Min) is approximately at the bottom, i.e., the stress distribution is extremely uneven, so that it is easy for the bone to collapse at the position bearing the largest stress. Conversely, according to FIG. 4A, it is known that when the dental implant of the embodiment of the disclosure is used and a vertical force is applied from the top of the built-in screw, positions where the surrounding bone receives the maximum stress and the minimum stress are all approximately at middle-depth positions, and the stress distribution is relatively even, which greatly avoids bone collapse. Moreover, the maximum stress in FIG. 4B is also much lower than the maximum stress in FIG. 4A.

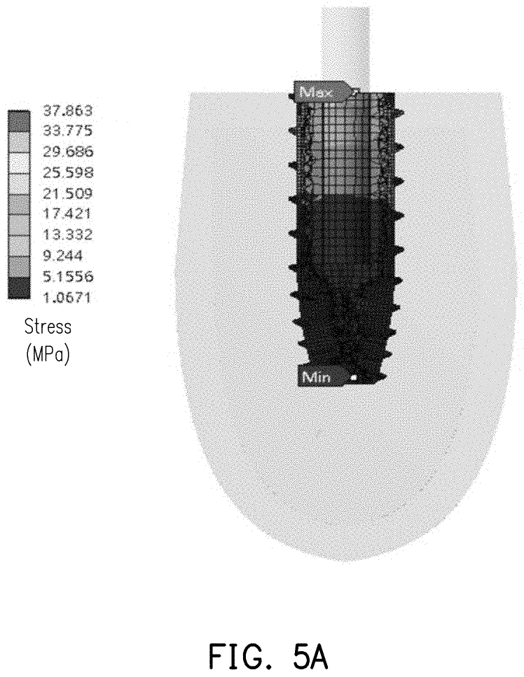

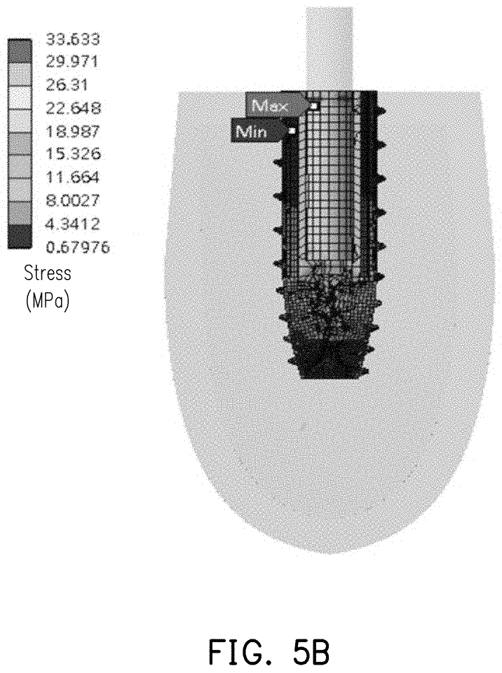

FIG. 5A and FIG. 5B are respectively stress distribution diagrams obtained through stress analysis of dental implants when a conventional dental implant and the dental implant of the embodiment of the disclosure are used. In FIG. 5A and FIG. 5B, the stress analysis is performed based on the model of FIG. 3, and a vertical force is applied from the top of the built-in screw. According to FIG. 5A, it is known that when a conventional dental implant is used and a vertical force is applied from the top of the built-in screw, the top of the conventional dental implant is a position subject to the largest stress, and a position subject to the least stress is approximately at the bottom, i.e., the stress distribution is extremely uneven, so that the conventional dental implant is easy to be damaged at the position subject to the largest stress. Conversely, according to FIG. 5B, it is known that when the dental implant of the embodiment of the disclosure is used and a vertical force is applied from the top of the built-in screw, positions where the dental implant of the embodiment of the disclosure receives the maximum stress and the minimum stress are quite close, and the stress distribution is relatively even, so that damage of the dental implant of the embodiment of the disclosure may be greatly avoided. Moreover, the maximum stress in FIG. 5B is also much lower than the maximum stress in FIG. 5A.

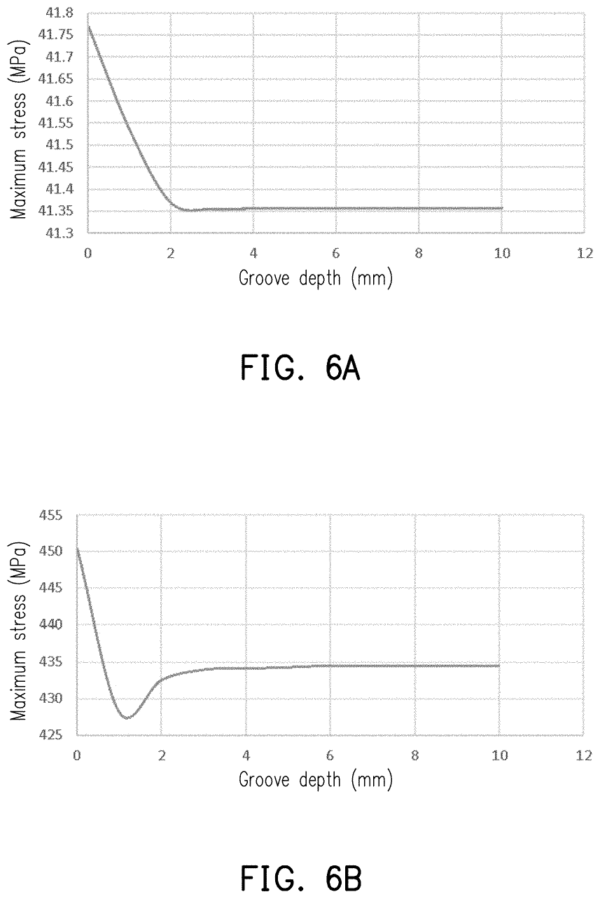

FIG. 6A and FIG. 6B are respectively diagrams showing a relationship between a maximum stress on the built-in screw and a depth of the strength adjusting structure when a vertical force and an oblique force are applied to the dental implant of the embodiment of the disclosure. Referring to FIG. 2 and FIG. 6A, it is known that when the first depth D20 of the strength adjusting structure 120 starts to be increased from 0, the maximum stress on the built-in screw generated when the vertical force is applied to the built-in screw is decreased significantly. Referring to 2 and FIG. 6B, it is known that when the first depth D20 of the strength adjusting structure 120 starts to be increased from 0, the maximum stress on the built-in screw generated when the oblique force is applied to the built-in screw is also decreased significantly.

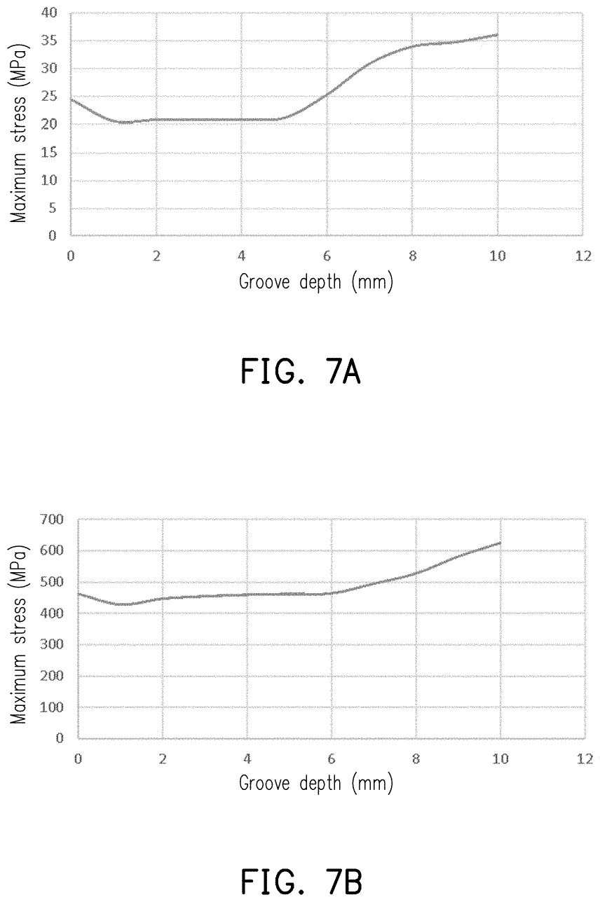

FIG. 7A and FIG. 7B are respectively diagrams showing a relationship between a maximum stress on the dental implant and a depth of the strength adjusting structure when a vertical force and an oblique force are applied to the dental implant of the embodiment of the disclosure. Referring to FIG. 2 and FIG. 7A, the strength adjusting structure 120 of the embodiment may be a strength weakening groove. According to the figures, it is known that when the first depth D20 of the strength adjusting structure 120 starts to be increased from 0, the maximum stress on the dental implant generated when the vertical force is applied to the built-in screw may be decreased. Referring to FIG. 2 and FIG. 7B, it is known that when the first depth D20 of the strength adjusting structure 120 starts to be increased from 0, the maximum stress on the dental implant generated when the oblique force is applied to the built-in screw is also decreased.

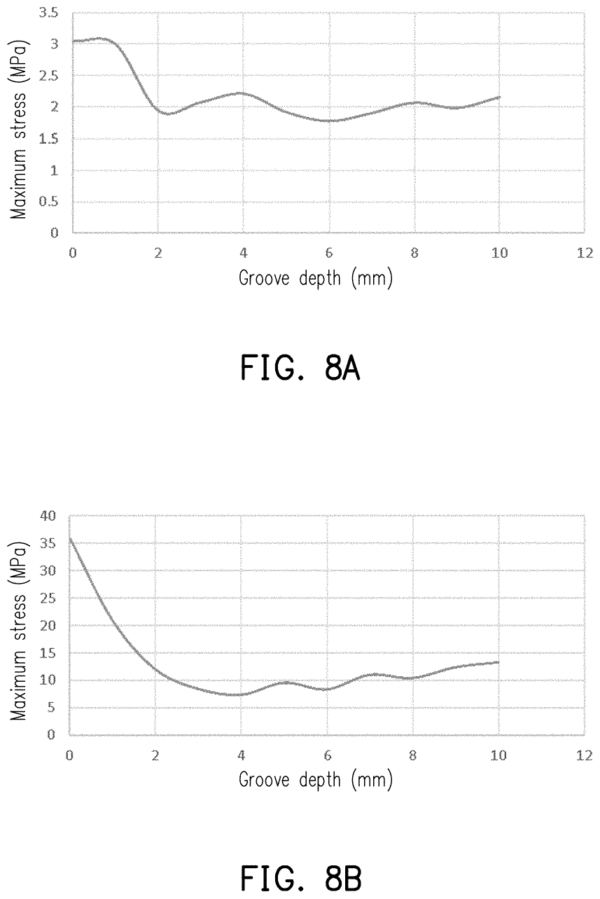

FIG. 8A and FIG. 8B are respectively diagrams showing a relationship between a maximum stress on a surrounding bone and a depth of the strength adjusting structure when a vertical force and an oblique force are applied to the dental implant of the embodiment of the disclosure. Referring to FIG. 2 and FIG. 8A, it is known that when the first depth D20 of the strength adjusting structure 120 starts to be increased from 0, the maximum stress on the surrounding bone generated when the vertical force is applied to the built-in screw has a trend of decrease. Referring to FIG. 2 and FIG. 8B, it is known that when the first depth D20 of the strength adjusting structure 120 starts to be increased from 0, the maximum stress on the surrounding bone generated when the oblique force is applied to the built-in screw also has a trend of decrease.

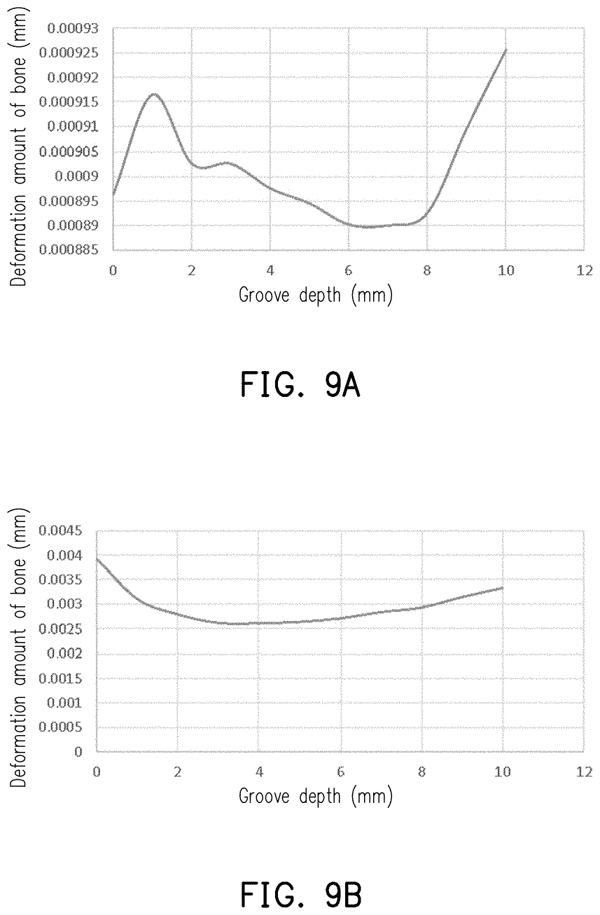

FIG. 9A and FIG. 9B are respectively diagrams showing a relationship between a maximum deformation amount of the surrounding bone and a depth of the strength adjusting structure when a vertical force and an oblique force are applied to the dental implant of the embodiment of the disclosure. Referring to FIG. 2 and FIG. 9A, it is known that when the first depth D20 of the strength adjusting structure 120 has a certain magnitude, the maximum deformation amount of the surrounding bone generated when the vertical force is applied to the built-in screw has a trend of decrease. Referring to FIG. 2 and FIG. 9B, it is known that when the first depth D20 of the strength adjusting structure 120 starts to be increased from 0, the maximum deformation amount of the surrounding bone generated when the oblique force is applied to the built-in screw also has a trend of decrease.

According to the above descriptions, it is proved once again that the dental implant 100 of the embodiment has a more uniform stress distribution when being subjected to the external force, which may prevent the dental implant 100 and the jawbone from being damaged, and increase the service life of the dental implant 100. Moreover, it may be found through stress analysis that when a ratio of the first depth D20 of the strength adjusting structure 120 to the second depth D10 of the central cavity 110 is greater than 0 and less than or equal to 0.8, the dental implant 100 may have a longer service life. For example, compared with the conventional dental implant, the maximum stress on the dental implant of the embodiment of the disclosure is reduced by about 7%, and the maximum stress on the surrounding bone is reduced by about 80%, which increases the stability after implantation by 33%.

In the embodiment, the dental implant 100 is, for example, formed integrally by using a single material. For example, the dental implant 100 with the central cavity 110 may be formed first by using an alloy, and then the strength adjusting structure 120 is excavated, but the disclosure is not limited thereto. In addition, the strength adjusting structure 120 of the embodiment continuously surrounds the central cavity 110. According to another aspect, the strength adjusting structure 120 of the embodiment is cylindrical, and the central cavity 110 is located in the cylindrical strength adjusting structure 120.

Referring to FIG. 2 again, in the embodiment, the dental implant 100 has a first minimum wall thickness T10 between the central cavity 110 and the strength adjusting structure 120, and the dental implant 100 has a second minimum wall thickness T20 between the strength adjusting structure 120 and the side surface S14.

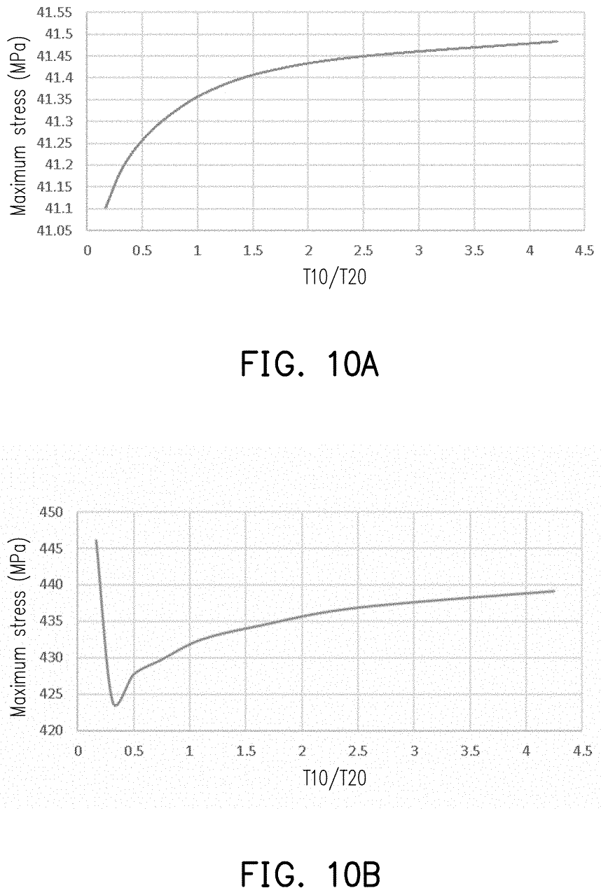

FIG. 10A and FIG. 10B are respectively diagrams showing a relationship between the maximum stress on the built-in screw and a ratio of the first minimum wall thickness to the second minimum wall thickness when a vertical force and an oblique force are applied to the dental implant of the embodiment of the disclosure. Refer to FIG. 2 and FIG. 10A, it is known that when the ratio of the first minimum wall thickness T10 to the second minimum wall thickness T20 (T10/T20) starts to be increased, the maximum stress on the built-in screw generated when the vertical force is applied to the built-in screw is increased accordingly. Referring to FIG. 2 and FIG. 10B, it is known that when the ratio of the first minimum wall thickness T10 to the second minimum wall thickness T20 (T10/T20) starts to be increased, the maximum stress on the built-in screw generated when the oblique force is applied to the built-in screw rises slowly after a significant drop.

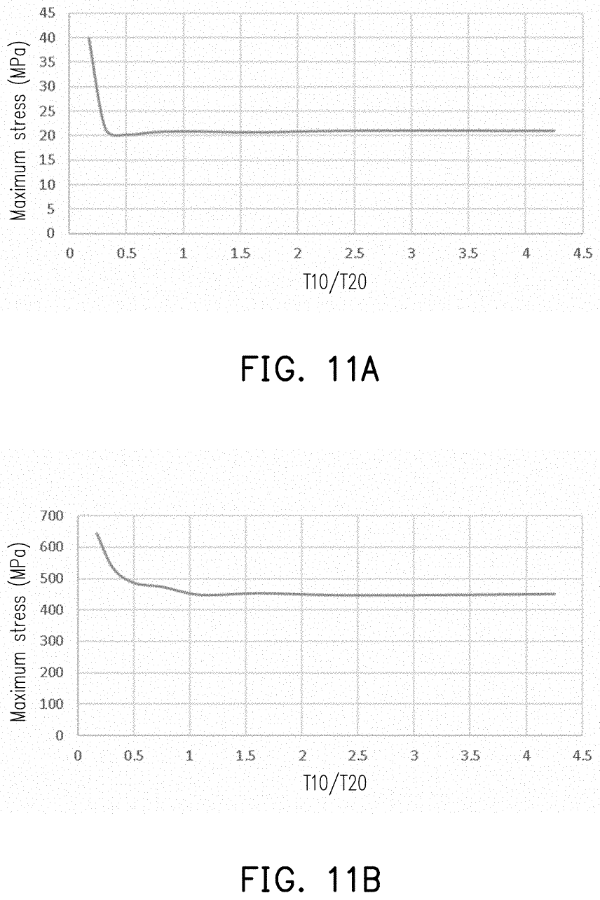

FIG. 11A and FIG. 11B are respectively diagrams showing a relationship between the maximum stress on the dental implant and a ratio of the first minimum wall thickness to the second minimum wall thickness when a vertical force and an oblique force are applied to the dental implant of the embodiment of the disclosure. Refer to FIG. 2 and FIG. 11A, it is known that when the ratio of the first minimum wall thickness T10 to the second minimum wall thickness T20 (T10/T20) starts to be increased, the maximum stress on the dental implant generated when the vertical force is applied to the built-in screw is decreased quickly and significantly. Referring to FIG. 2 and FIG. 11B, it is known that when the ratio of the first minimum wall thickness T10 to the second minimum wall thickness T20 (T10/T20) starts to be increased, the maximum stress on the dental implant generated when the oblique force is applied to the built-in screw is decreased accordingly.

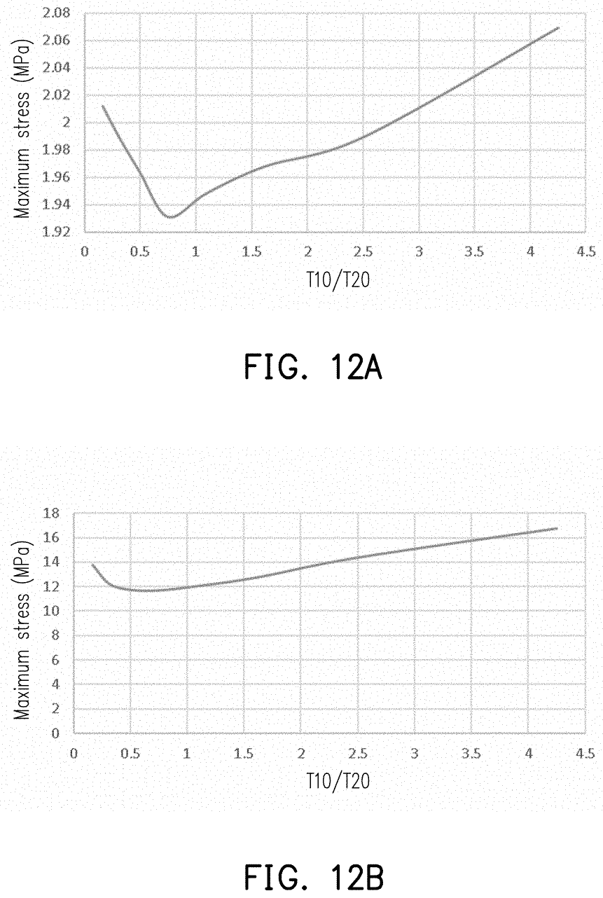

FIG. 12A and FIG. 12B are respectively diagrams showing a relationship between the maximum stress on the surrounding bone and a ratio of the first minimum wall thickness to the second minimum wall thickness when a vertical force and an oblique force are applied to the dental implant of the embodiment of the disclosure. Refer to FIG. 2 and FIG. 12A, it is known that when the ratio of the first minimum wall thickness T10 to the second minimum wall thickness T20 (T10/T20) starts to be increased, the maximum stress on the surrounding bone generated when the vertical force is applied to the built-in screw is decreased first and then increased. Referring to FIG. 2 and FIG. 12B, it is known that when the ratio of the first minimum wall thickness T10 to the second minimum wall thickness T20 (T10/T20) starts to be increased, the maximum stress on the surrounding bone generated when the oblique force is applied to the built-in screw is also decreased first and then increased.

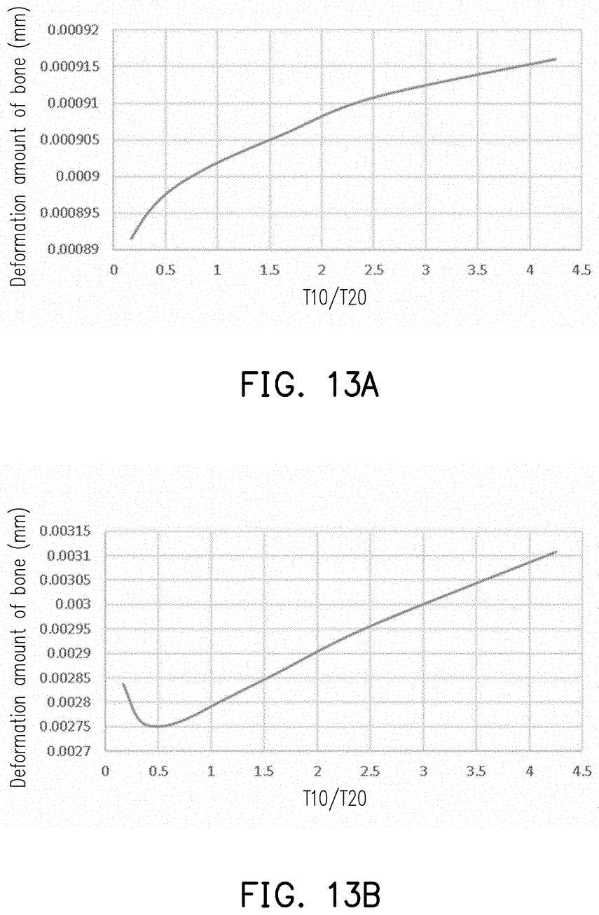

FIG. 13A and FIG. 13B are respectively diagrams showing a relationship between the maximum deformation amount of the surrounding bone and a ratio of the first minimum wall thickness to the second minimum wall thickness when a vertical force and an oblique force are applied to the dental implant of the embodiment of the disclosure. Refer to FIG. 2 and FIG. 13A, it is known that when the ratio of the first minimum wall thickness T10 to the second minimum wall thickness T20 (T10/T20) starts to be increased, the maximum deformation amount of the surrounding bone generated when the vertical force is applied to the built-in screw is increased accordingly. Referring to FIG. 2 and FIG. 13B, it is known that when the ratio of the first minimum wall thickness T10 to the second minimum wall thickness T20 (T10/T20) starts to be increased, the maximum deformation amount of the surrounding bone generated when the oblique force is applied to the built-in screw is first decreased significantly and then increased.

It may be found through stress analysis that the first minimum wall thickness T10 of the dental implant 100 between the central cavity 110 and the strength adjusting structure 120 may be greater than or equal to 0.1 mm. In addition, the ratio of the first minimum wall thickness T10 of the dental implant 100 between the central cavity 110 and the strength adjusting structure 120 and the second minimum wall thickness T20 of the dental implant 100 between the strength adjusting structure 120 and the side surface S14 is greater than or equal to 0.1 and less than or equal to 5. In this way, the dental implant 100 has a longer service life.

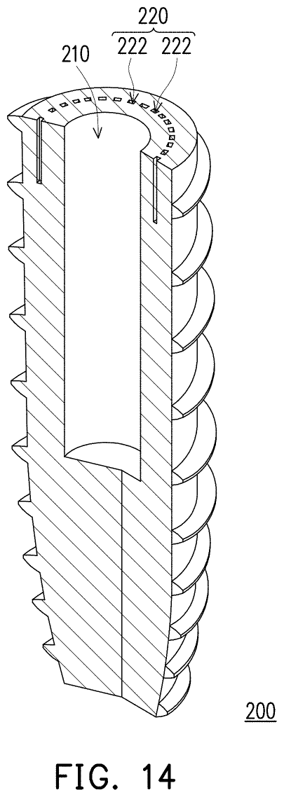

FIG. 14 is a schematic cross-sectional view of a dental implant according to another embodiment of the disclosure. Referring to FIG. 14, a dental implant 200 of the embodiment is similar to the dental implant 100 of FIG. 1, and a difference there between is that the strength adjusting structure 220 of the embodiment includes a plurality of independent grooves 222 separated from each other, and the independent grooves 222 are distributed around the central cavity 210. According to another aspect, the strength adjusting structure 220 of the embodiment discontinuously surrounds the central cavity 210. The strength adjusting structure 220 of the embodiment is, for example, arranged around the central cavity 210 in a rod shape. A number of the independent grooves 222 is, for example, greater than or equal to 5, and the number of the independent grooves 222 may also be less than or equal to 30.

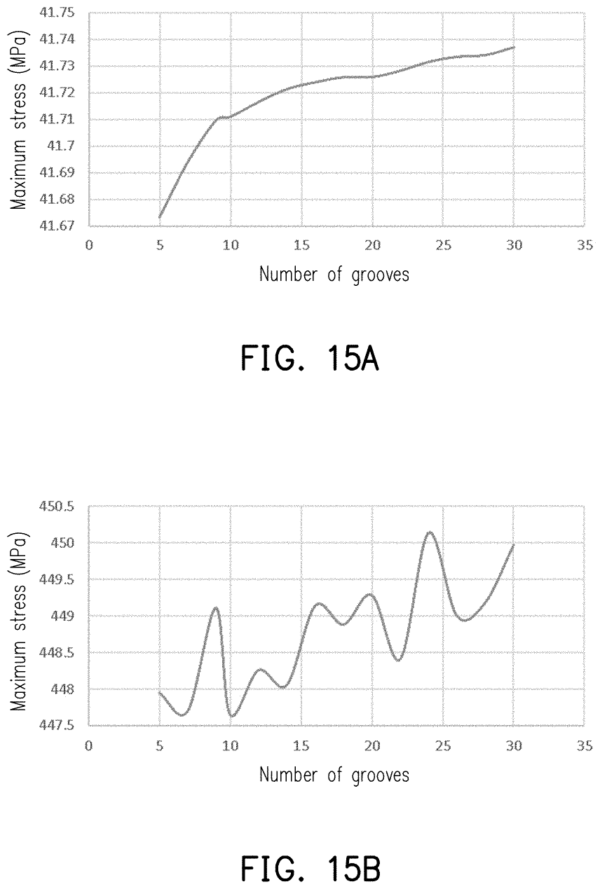

FIG. 15A and FIG. 15B are respectively diagrams showing a relationship between the maximum stress on the built-in screw and the number of the independent grooves of the strength adjusting structure when a vertical force and an oblique force are applied to the dental implant of the embodiment of the disclosure. Referring to FIG. 14 and FIG. 15A, it is known that when the number of the independent grooves starts to be increased from 5, the maximum stress on the built-in screw generated when the vertical force is applied to the built-in screw starts to be increased. Referring to FIG. 14 and FIG. 15B, it is known that when the number of the independent grooves starts to be increased from 5, the maximum stress on the built-in screw generated when the oblique force is applied to the built-in screw has a trend of increase.

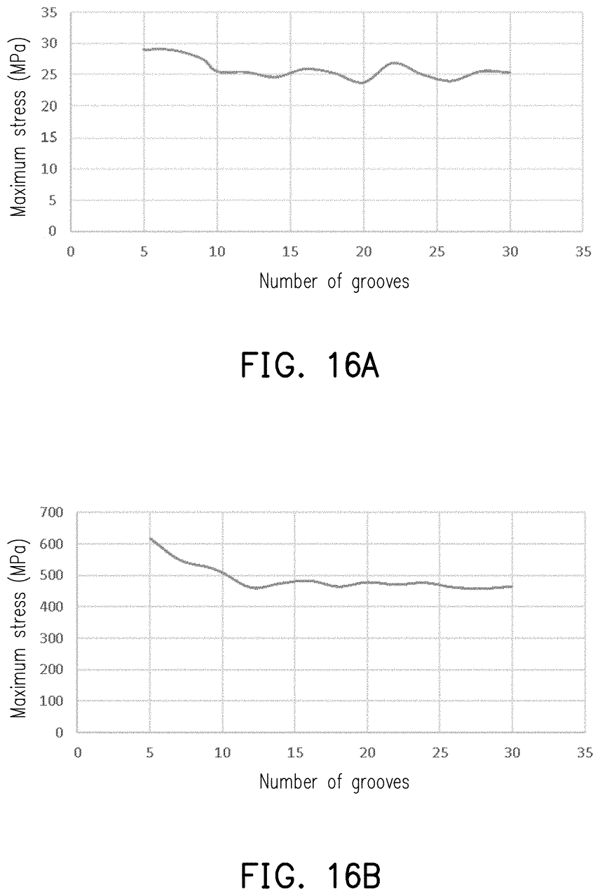

FIG. 16A and FIG. 16B are respectively diagrams showing a relationship between the maximum stress on the dental implant and the number of the independent grooves of the strength adjusting structure when a vertical force and an oblique force are applied to the dental implant of the embodiment of the disclosure. Referring to FIG. 14 and FIG. 16A, it is known that when the number of the independent grooves starts to be increased from 5, the maximum stress on the dental implant generated when the vertical force is applied to the built-in screw is slightly decreased. Referring to FIG. 14 and FIG. 16B, it is known that when the number of the independent grooves starts to be increased from 5, the maximum stress on the dental implant generated when the oblique force is applied to the built-in screw is also slightly decreased.

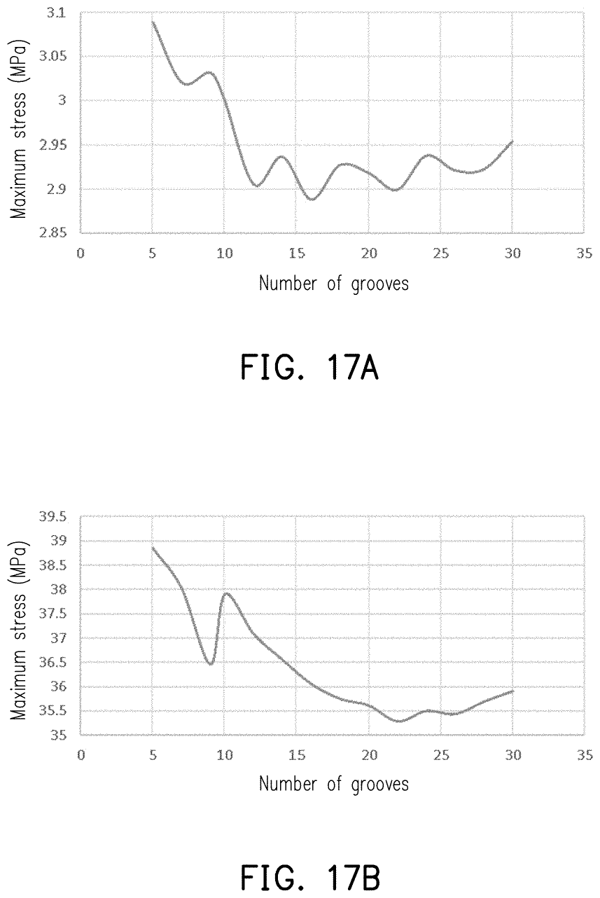

FIG. 17A and FIG. 17B are respectively diagrams showing a relationship between the maximum stress on the surrounding bone and the number of the independent grooves of the strength adjusting structure when a vertical force and an oblique force are applied to the dental implant of the embodiment of the disclosure. Referring to FIG. 14 and FIG. 17A, it is known that when the number of the independent grooves starts to be increased from 5, the maximum stress on the surrounding bone generated when the vertical force is applied to the built-in screw is significantly decreased. Referring to FIG. 14 and FIG. 17B, it is known that when the number of the independent grooves starts to be increased from 5, the maximum stress on the surrounding bone generated when the oblique force is applied to the built-in screw is also significantly decreased.

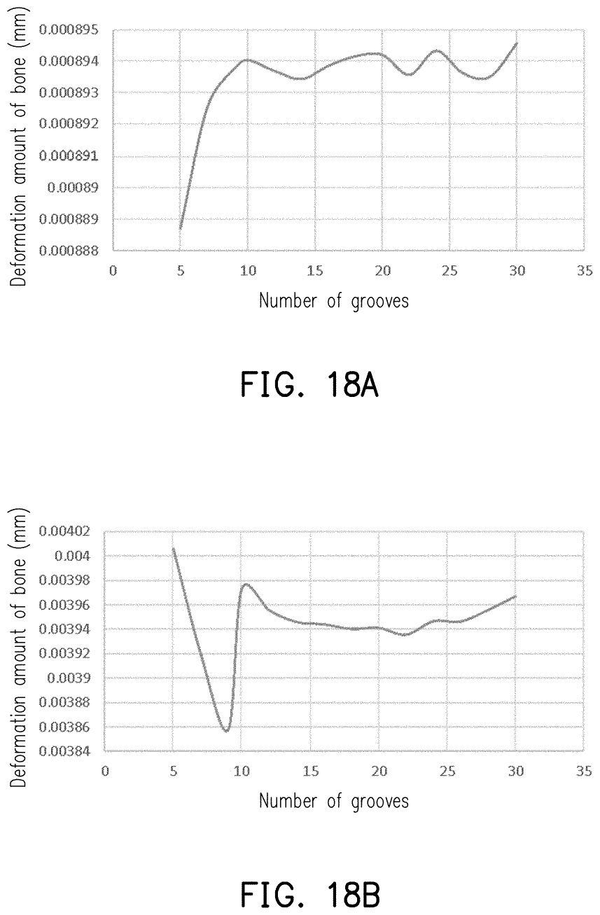

FIG. 18A and FIG. 18B are respectively diagrams showing a relationship between the maximum deformation amount of the surrounding bone and the number of the independent grooves of the strength adjusting structure when a vertical force and an oblique force are applied to the dental implant of the embodiment of the disclosure. Referring to FIG. 14 and FIG. 18A, it is known that when the number of the independent grooves starts to be increased from 5, the maximum deformation amount of the surrounding bone generated when the vertical force is applied to the built-in screw tends to be fixed after increasing. Referring to FIG. 14 and FIG. 18B, it is known that when the number of the independent grooves starts to be increased from 5, the maximum deformation amount of the surrounding bone generated when the oblique force is applied to the built-in screw is first decreased and then increased, and then tends to be stable.

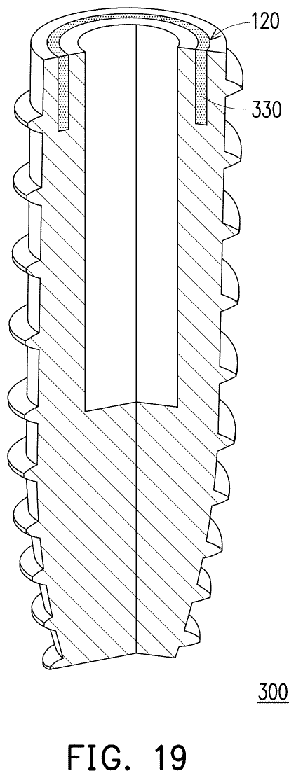

FIG. 19 is a schematic cross-sectional view of a dental implant according to still another embodiment of the disclosure. Referring to FIG. 19, a dental implant 300 of the embodiment is similar to the dental implant 100 of FIG. 1, and a difference there between is that the strength adjusting structure 120 of the embodiment is filled with a polymer material 330. By filling and selecting the polymer material 330, rigidity and toughness of the dental implant 300 may be adjusted. The polymer material 330 may also provide a buffering effect, so that the stress is transmitted more dispersedly, which may also prevent growth of bacteria in the strength adjusting structure 120.

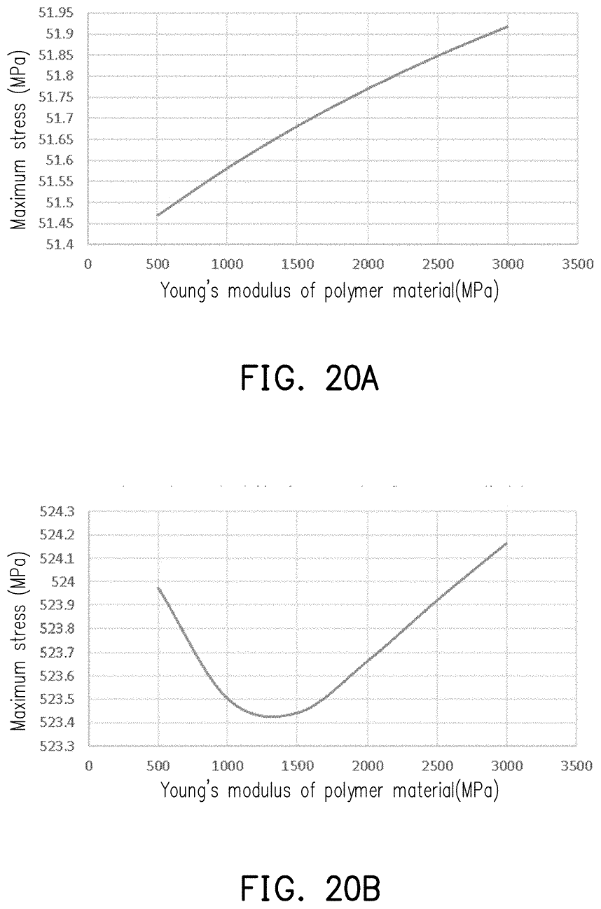

FIG. 20A and FIG. 20B are respectively diagrams showing a relationship between the maximum stress on the built-in screw and Young's modulus of the polymer material when a vertical force and an oblique force are applied to the dental implant of the embodiment of the disclosure. Referring to FIG. 19 and FIG. 20A, it is known that when the Young's modulus of the polymer material 330 is increased, the maximum stress on the built-in screw generated when the vertical force is applied to the built-in screw is increased accordingly. Referring to FIG. 19 and FIG. 20B, it is known that when the Young's modulus of the polymer material 330 is increased, the maximum stress on the built-in screw generated when the oblique force is applied to the built-in screw is decreased first and then increased.

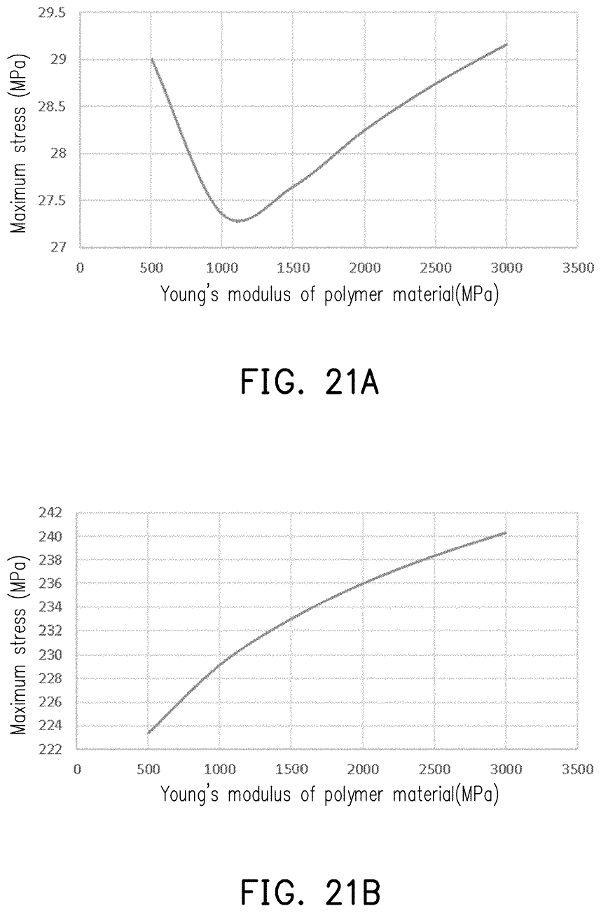

FIG. 21A and FIG. 21B are respectively diagrams showing a relationship between the maximum stress on the dental implant and Young's modulus of the polymer material when a vertical force and an oblique force are applied to the dental implant of the embodiment of the disclosure. Referring to FIG. 19 and FIG. 21A, it is known that when the Young's modulus of the polymer material 330 is increased, the maximum stress on the dental implant generated when the vertical force is applied to the built-in screw is increased first and then decreased. Referring to FIG. 19 and FIG. 21B, it is known that when the Young's modulus of the polymer material 330 is increased, the maximum stress on the dental implant generated when the oblique force is applied to the built-in screw is increased.

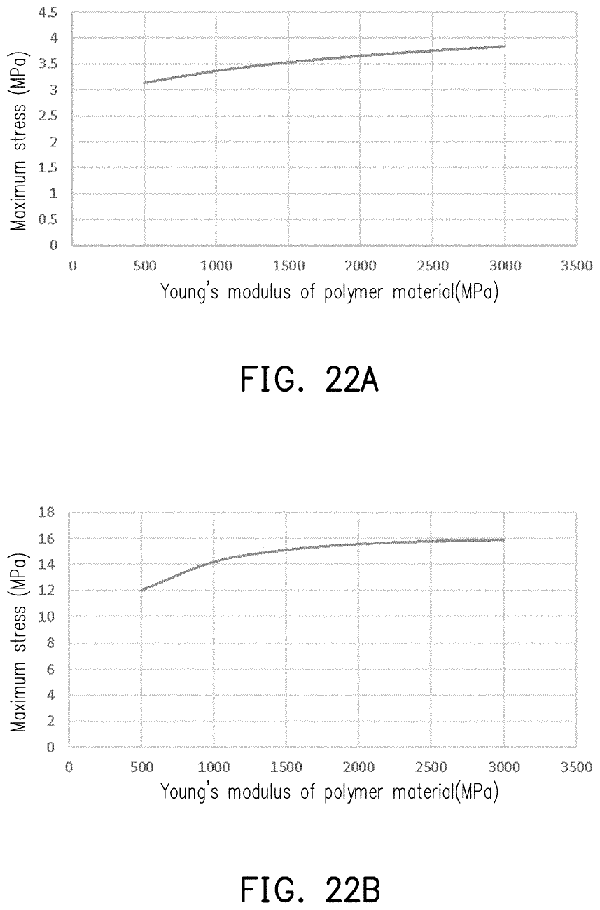

FIG. 22A and FIG. 22B are respectively diagrams showing a relationship between the maximum stress on the surrounding bone and Young's modulus of the polymer material when a vertical force and an oblique force are applied to the dental implant of the embodiment of the disclosure. Referring to FIG. 19 and FIG. 22A, it is known that when the Young's modulus of the polymer material 330 is increased, the maximum stress on the surrounding bone generated when the vertical force is applied to the built-in screw is increased slowly. Referring to FIG. 19 and FIG. 22B, it is known that when the Young's modulus of the polymer material 330 is increased, the maximum stress on the surrounding bone generated when the oblique force is applied to the built-in screw is increased slowly.

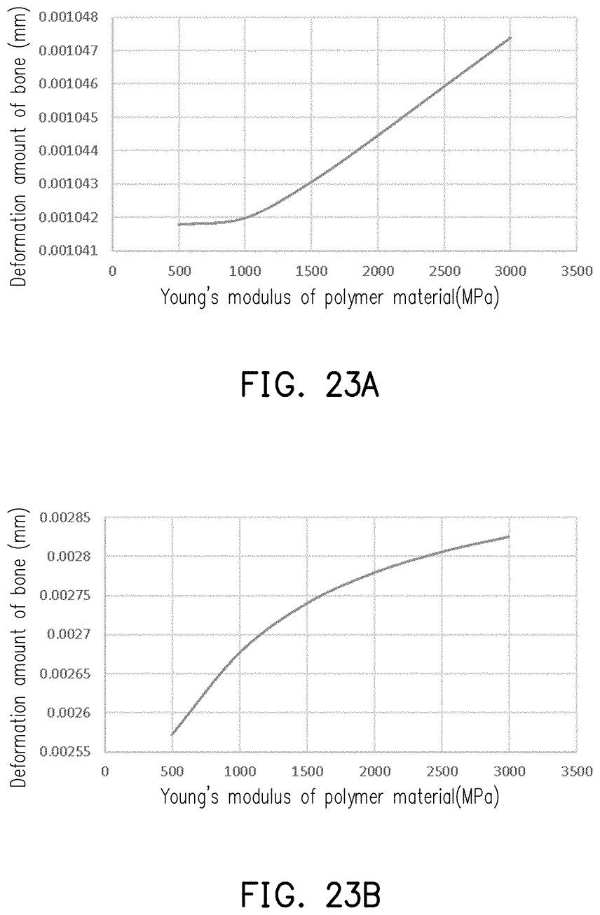

FIG. 23A and FIG. 23B are respectively diagrams showing a relationship between the maximum deformation amount of the surrounding bone and Young's modulus of the polymer material when a vertical force and an oblique force are applied to the dental implant of the embodiment of the disclosure. Referring to FIG. 19 and FIG. 23A, it is known that when the Young's modulus of the polymer material 330 is increased, the deformation amount of the surrounding bone generated when the vertical force is applied to the built-in screw is increased accordingly. Referring to FIG. 19 and FIG. 23B, it is known that when the Young's modulus of the polymer material 330 is increased, the deformation amount of the surrounding bone generated when the oblique force is applied to the built-in screw is increased accordingly.

Through the stress analysis, it is found that the Young's modulus of the polymer material in the strength adjusting structure should not be too large, for example, the Young's modulus is greater than or equal to 500 MPa and less than or equal to 4000 MPa.

In summary, in the dental implant of the disclosure, the strength adjusting structure may simulate periodontal ligament around the natural tooth to provide similar functions. Therefore, the dental implant of the disclosure may mitigate the problem of excessive concentration of stress applied to the dental pin and the built-in screw. In addition, due to a change of a stress transmission path, the stress on the jawbone and the deformation amount of the jawbone are also significantly reduced, which may improve the stability of the dental implant after implantation and prolong the service life of the dental implant.

It will be apparent to those skilled in the art that various modifications and variations can be made to the structure of the disclosed embodiments without departing from the scope or spirit of the disclosure. In view of the foregoing, it is intended that the disclosure cover modifications and variations of this disclosure provided they fall within the scope of the following claims and their equivalents.

What is claimed is:

1. A dental implant, having a central cavity and a strength adjusting structure, wherein a first opening of the central cavity and a second opening of the strength adjusting structure are both located on a top surface of the dental implant, the strength adjusting structure is located between the central cavity and a side surface of the dental implant, and a ratio of a first depth of the strength adjusting structure in a length direction of the dental implant to a second depth of the central cavity in the length direction of the dental implant is greater than 0 and less than or equal to 0.8.

2. The dental implant as claimed in claim 1, wherein the strength adjusting structure continuously surrounds the central cavity.

3. The dental implant as claimed in claim 1, wherein the strength adjusting structure comprises a plurality of independent grooves separated from each other, and the independent grooves are distributed around the central cavity.

4. The dental implant as claimed in claim 3, wherein a number of the independent grooves is less than or equal to 30.

5. The dental implant as claimed in claim 1, wherein the strength adjusting structure is filled with a polymer material.

6. The dental implant as claimed in claim 1, wherein a Young's modulus of the polymer material in the strength adjusting structure is greater than or equal to 500 MPa and less than or equal to 4000 MPa.

7. The dental implant as claimed in claim 1, wherein a minimum wall thickness of the dental implant between the central cavity and the strength adjusting structure is greater than or equal to 0.1 mm.

8. The dental implant as claimed in claim 1, wherein a ratio of a first minimum wall thickness of the dental implant between the central cavity and the strength adjusting structure to a second minimum wall thickness of the dental implant between the strength adjusting structure and the side surface is greater than or equal to 0.1 and less than or equal to 5.
